(19) United States
(12) Patent Application Publication
(10) Pub. No.: US 2010/0031717 A1
(43) Pub. Date: Feb. 11, 2010

(54) INTERCHANGABLE CORE ADAPTER AND METHOD OF USING SAME

(76) Inventors: Alan E. Lurie, Centerport, NY (US); Costantino Cafaro, Plainview, NY (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/534,924

(22) Filed: Aug. 4, 2009

Related U.S. Application Data
(60) Provisional application No. 61/087,839, filed on Aug. 11, 2008.

(51) Int. Cl. E05B 15/00

(52) U.S. Cl. 70/385

(57) ABSTRACT

An interchangeable core lock adapter is disclosed. The interchangeable core lock adapter comprises a body portion including an outer wall and an inner wall. The outer wall is configured and dimensioned for operable engagement within a large format interchangeable core housing. The inner wall configured is and dimensioned for operable reception of a small format interchangeable core lock.

### CROSS-REFERENCE TO RELATED APPLICATIONS

The present application claims the benefit of and priority to U.S. Provisional Patent Application Ser. No. 61/087,839 filed on Aug. 11, 2008, the entire contents of which being herein incorporated by reference in its entirety.

### BACKGROUND

The present disclosure relates generally to an adapter for use with locks having interchangeable cores. More particularly, the present disclosure relates to an adapter for allowing a lock having a Large Format Interchangeable Core (LFIC) Cavity to accept a Small Format Interchangeable Core (SFIC).

Locks utilizing a LFIC and/or SFIC are commonly used for various applications to restrict access. As used herein, “lock” is intended to include the housing that contains the bolt, latch or cam that is used to secure a door, drawer, etc. As such, the “locks,” as used herein, are configured for insertion within a particular LFIC or SFIC. For example, such locks are typically used on doors, showcases, display cases, etc. and are unlockable via a first mechanical key (an “operating key”; as used herein, “key” is intended to include a mechanical key and/or an access card). Additionally, locks having interchangeable cores typically accept a second key (a “control key”) which enables the entire lock core to be removed from its housing (e.g., in a door handle). The control key generally operates a locking lug that is configured to selectively engage an opening within the housing of the lock. When engaged with the opening, the lug physically prevents the core from being removed from the housing.

The main difference between LFICs and SFICs is the size. An LFIC is commonly defined as an interchangeable core that is too large to fit into an SFIC housing. Likewise, while an SFIC can physically fit into the housing of an LFIC, the fit is a very loose fit, and thus not functional. Accordingly, if a door handle, for example, includes an LFIC lock, it is necessary to replace the entire door handle to enable the door handle to be operated by an SFIC lock and associated keys.

### SUMMARY

The present disclosure relates to an interchangeable core lock adapter. The interchangeable core lock adapter comprises a body portion including an outer wall and an inner wall. The outer wall is configured and dimensioned for operable engagement within a large format interchangeable core housing. The inner wall configured is and dimensioned for operable reception of a small format interchangeable core lock.

In disclosed embodiments, the body portion includes a finger disposed in moveable relation therewith. The finger is configured to be moved into engagement with a portion of a large format interchangeable core housing.

In disclosed embodiments, the body portion includes a length and an elongated slot extending along a portion of the length. The elongated slot is configured to engage a latch of a small format interchangeable core lock.

In disclosed embodiments, the elongated slot includes a proximal edge configured to prevent proximal translation of a latch of a small format interchangeable core lock engaged therewith.

In disclosed embodiments, the body portion forms a figure eight-like shape.

In disclosed embodiments, the finger is moveable from a first position where the finger is in substantial alignment with the figure eight-like shape, to a second position where the finger is out of alignment with the figure eight-like shape.

The present disclosure also relates to a method of enabling a large format interchangeable core cavity to accept a small format interchangeable core lock. The method comprises the steps of:
providing an interchangeable core lock adapter including a body portion;
positioning the interchangeable core lock adapter within a large format interchangeable core cavity such that an outer wall of the body portion operably engages an inner wall of the large format interchangeable core cavity, and such that an inner wall of the body portion is configured and dimensioned to accept a small format interchangeable core lock; and
moving a finger of the interchangeable core lock adapter into engagement with a groove of the large format interchangeable core cavity.

In disclosed embodiments of the method, the body portion includes a length and an elongated slot extending along a portion of the length. The elongated slot is configured to engage a latch of a small format interchangeable core lock.

In disclosed embodiments of the method, the elongated slot includes a proximal edge configured to prevent proximal translation of a latch of a small format interchangeable core lock engaged therewith.

In disclosed embodiments of the method, the body portion forms a figure eight-like shape.

In disclosed embodiments of the method, the step of moving the finger is further defined by moving the finger from a first position where the finger is in substantial alignment with the figure eight-like shape, to a second position where the finger is out of alignment with the figure eight-like shape.

### BRIEF DESCRIPTION OF DRAWINGS

Embodiments of the present disclosure are described hereinbelow with reference to the drawings wherein:

FIG. 1 is a perspective view of an interchangeable core adapter, in accordance with the embodiments of the present disclosure, within a Large Format Interchangeable Core (LFIC) housing and having a Small Format Interchangeable Core (SFIC) lock inserted therein.

FIG. 2 is a perspective view of the interchangeable core adapter and the LFIC of FIG. 1.

FIG. 3 is an exploded view of the interchangeable core adapter, the LFIC and the SFIC of FIG. 1.

FIG. 4 is a perspective view of the interchangeable core adapter of FIGS. 1-3.

FIG. 5 is a cross-sectional view of the interchangeable core adapter through line 5-5 of FIG. 4, showing a finger in a first position.

FIG. 6 is a cross-sectional view of the interchangeable core adapter through line 5-5 of FIG. 4, showing a finger in a second position.

FIG. 7 is a perspective view of the LFIC of FIGS. 1-3.

FIG. 8 is a front view of the LFIC of FIGS. 1-3 and 7.

FIG. 9 is the LFIC of FIG. 8 having the interchangeable core adapter inserted therein.

### DESCRIPTION

Embodiments of the presently disclosed interchangeable core adapter are described in detail with reference to the drawings wherein like numerals designate identical or corresponding elements in each of the several views. As is common in the art, the term “proximal” refers to that part or component closer to the user, while the term “distal” refers to that part or component farther away from the user.

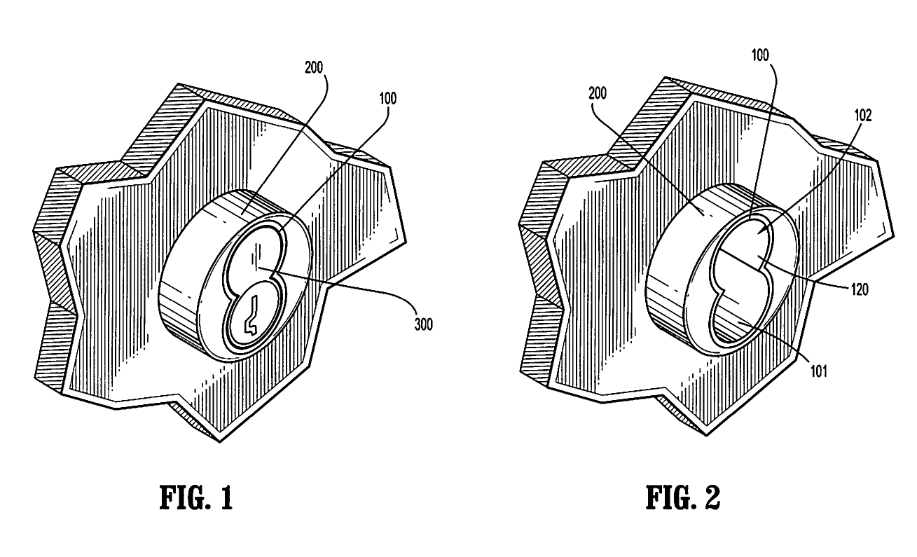

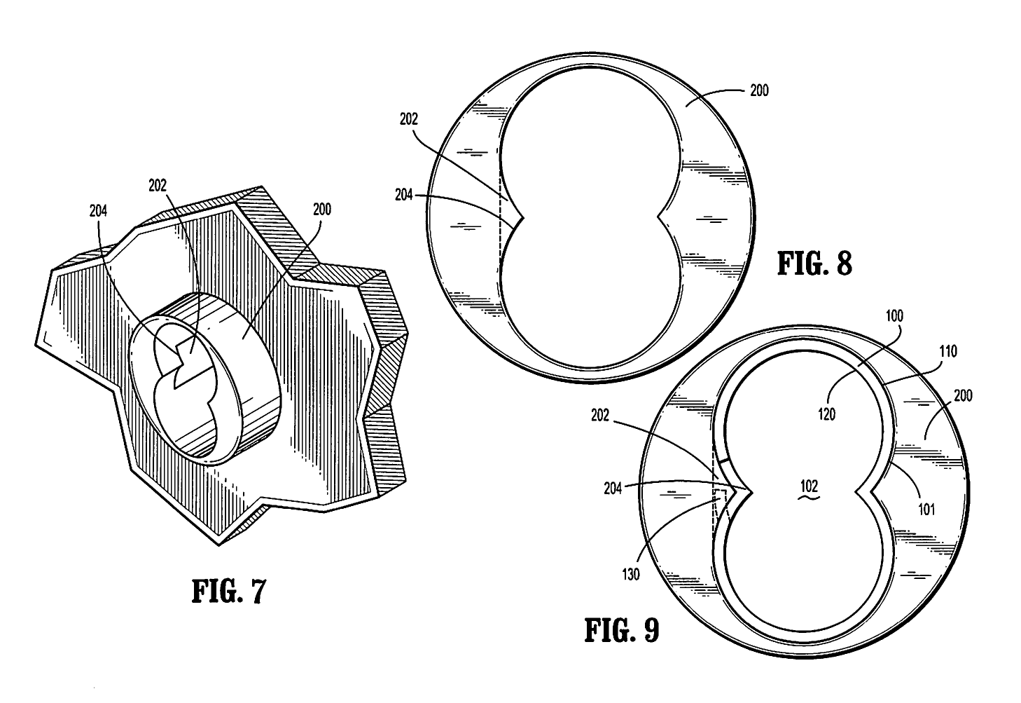

In combination with the accompanying FIGS. 1-9, an interchangeable core adapter 100 of the present disclosure is described herein. With reference to FIGS. 1-3, adapter 100 generally includes a figure-eight body portion 101 defining an opening 102 and is configured for insertion into an LFIC housing 200. Outer wall 110 of adapter 100 is appropriately sized for operable insertion into LFIC housing 200. Since the dimensions of LFIC housings 200 are not always consistent, it is envisioned that adapter 100 can be made of any suitable size and shape to operably fit within any particular LFIC housing 200. Inner wall 120 of adapter is appropriately sized and shaped to substantially mimic the size and shape of the outer walls of a housing (not shown) for an SFIC lock 300, thus enabling an SFIC lock 300 to operably fit therein.

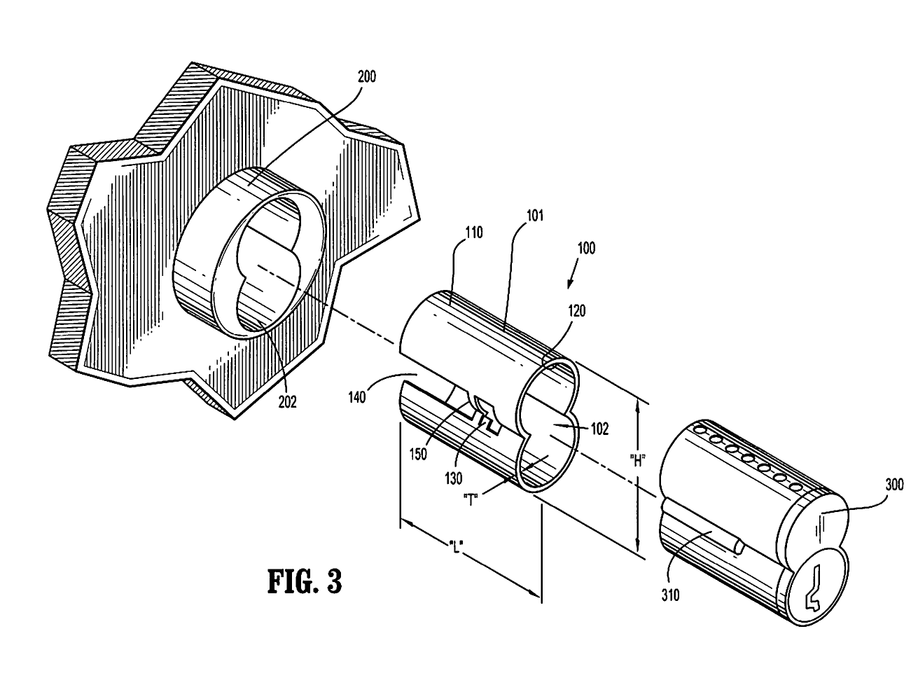

Referring now to FIGS. 3-9, adapter 100 includes a finger 130 (FIGS. 3-6 and 9) thereon. Finger 130 is configured to fit into a groove 202 of LFIC housing 200 and to engage a lip 204 thereof (FIGS. 7-9). In use, adapter 100 is inserted into LFIC housing 200, and finger 130 is moved (e.g., via a pliers-like tool) from substantial alignment with figure eight-like shape of body portion 101, into engagement with groove 202/lip 204 (and out of alignment with figure eight-like shape of body portion 101. Thus, as can be appreciated, finger 130 functions similarly to a latch of an LFIC. That is, finger 130 locks adapter 100 within LFIC housing 200 (i.e., prevents proximal movement of adapter 100 with respect to LFIC housing 200), as an LFIC latch locks the LFIC lock (not shown) with LFIC housing 200. It is envisioned that once finger 130 is moved into engagement with groove 202/lip 204, finger 130 is substantially prevented from disengagement therewith (e.g., without the aid of an additional tool).

While the illustrated embodiments show finger 130 disposed at one location on adapter 100, it is envisioned that finger 130 may be disposed at any other suitable location, e.g., to substantially align with a corresponding groove/lip (or other structure) of LFIC housing 200. It is also envisioned that adapter 100 includes multiple fingers 130 such that adapter 100 can operably engage a variety of LFIC housings.

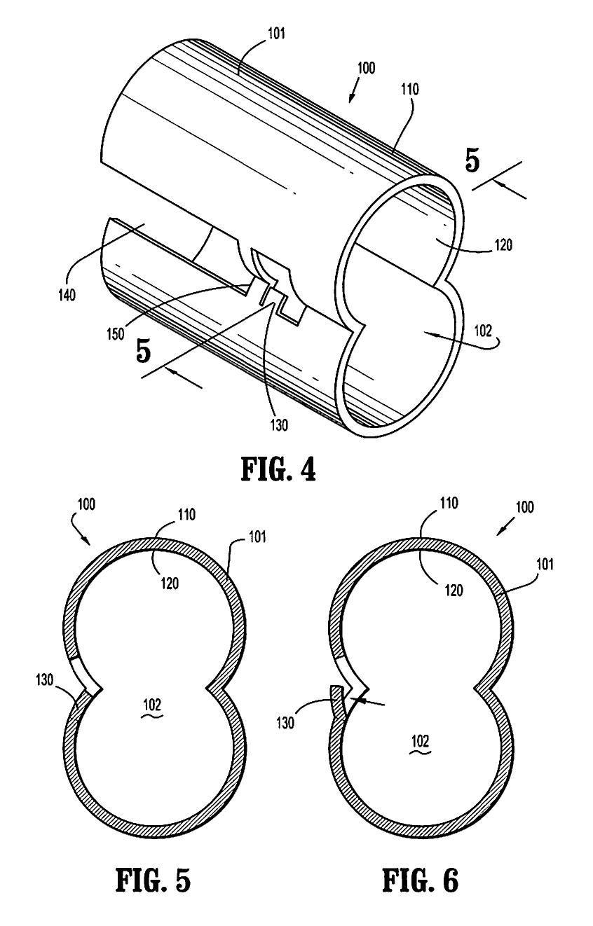

With reference to FIGS. 3 and 4, opening 102 of adapter 100 is sized and dimensioned to resemble the opening of an SFIC housing (not shown). Accordingly, adapter 100 is configured to operably accept an SFIC lock 300 therein. Since there are a variety of styles of LFICs and SFICs, the actual shape and/or size of adapter 100 illustrated and described herein is not intended to be limiting. That is, adapter 100 can be configured to fit into any LFIC and accept any SFIC without departing from the scope of the present disclosure. For example, a particular adapter 100 of the present disclosure includes a length “L,” a height “H,” and its walls define a thickness “T.” In disclosed embodiments length “L” is between about 1.000 inches and about 1.300 inches, and may be approximately 1.175 inches; height “H” is between about 0.800 inches and about 1.250 inches, and may be approximately 1.055 inches; and thickness “T” is between about 0.05 inches and about 0.08 inches, and may be approximately 0.065 inches. As can be appreciated, adapter 100 may include different dimensions to accommodate a particular LFIC and/or a particular SFIC.

An elongated slot 140 extends along a portion of length “L.” As shown in FIG. 3, slot 140 proximally terminates at an edge 150. Slot 140 is configured to engage a corresponding latch 310 of SFIC lock 300. That is, when SFIC lock 300 is within adapter 100, latch 310 is movable (e.g., via a control key) into engagement with slot 140, thus selectively securing SFIC lock 300 within adapter 100. As can be appreciated, edge 150 physically prevents latch 310 (and thus SFIC lock 300) from proximal translation.

Therefore, as can be appreciated, adapter 100 allows an assembly (e.g., a door handle assembly) that includes an LFIC housing 200 the ability to accept an SFIC lock 300, including SFIC locks configured to be operated by a mechanical key (not shown).

It is envisioned that adapter 100 can be made of any suitable material including brass, zinc, aluminum, steel, plastic, etc., or any combination thereof.

The present disclosure also relates to methods of enabling a relatively large lock cavity (e.g., configured for a large format interchangeable core or LFIC) to accept a relatively small lock (e.g., a small format interchangeable core lock or SFIC lock). A disclosed method includes the steps of providing an interchangeable core lock adapter 100, such as that described above; positioning adapter 100 within a LFIC cavity or housing 200 such that outer wall 110 of adapter 100 engages an inner wall 202 of LFIC cavity 200, and such that inner wall 120 of adapter 100 is configured and dimensioned to accept a SFIC lock 300; and moving finger 130 of adapter 100 into engagement with groove 202 of LFIC cavity 200.

It is also envisioned that an adapter 100′ (not shown) of the present disclosure is made from a spring steel-type material. Here, adapter 100′ is compressible from a first, expanded state, to a second compressed state, and is biased towards its expanded state. The size of LFIC cavity 200 is between the dimensions of adapter 100′ in its first, expanded state, and its second compressed state. Thus, adapter 100′ can be compressed (e.g., squeezed by hand or a tool), and slid into LFIC cavity 200. Due to the nature of its material, adapter 100′ would then expand towards, and into contact with inner walls of LFIC cavity 200, thus resulting in a frictional fit arrangement therebetween. As can be appreciated, in such an embodiment, finger 130 would not be necessary.

While the above description contains many specifics, these specifics should not be construed as limitations on the scope of the present disclosure, but merely as illustrations of various embodiments thereof. Therefore, the above description should not be construed as limiting, but merely as exemplifications of various embodiments.

Those skilled in the art will envision other modifications within the scope and spirit of the claims appended hereto.

1. An interchangeable core lock adapter, comprising:
a body portion including:
an outer wall configured and dimensioned for operable engagement within a large format interchangeable core housing; and
an inner wall configured and dimensioned for operable reception of a small format interchangeable core lock.

2. The interchangeable core lock adapter of claim 1, wherein the body portion includes a finger disposed in moveable relation therewith, the finger configured to be moved into engagement with a portion of a large format interchangeable core housing.

3. The interchangeable core lock adapter of claim 1, wherein the body portion includes a length and an elongated slot extending along a portion of the length, the elongated slot being configured to engage a latch of a small format interchangeable core lock.

4. The interchangeable core lock adapter of claim 3, wherein the elongated slot includes a proximal edge configured to prevent proximal translation of a latch of a small format interchangeable core lock engaged therewith.

5. The interchangeable core lock adapter of claim 1, wherein the body portion forms a figure eight-like shape.

6. The interchangeable core lock adapter of claim 2, wherein the body portion forms a figure eight-like shape.

7. The interchangeable core lock adapter of claim 6, wherein the finger is moveable from a first position where the finger is in substantial alignment with the figure eight-like shape, to a second position where the finger is out of alignment with the figure eight-like shape.

8. A method of enabling a large format interchangeable core cavity to accept a small format interchangeable core lock, the method comprising the steps of:
providing an interchangeable core lock adapter including a body portion;
positioning the interchangeable core lock adapter within a large format interchangeable core cavity such that an outer wall of the body portion operably engages an inner wall of the large format interchangeable core cavity, and such that an inner wall of the body portion is configured and dimensioned to accept a small format interchangeable core lock; and
moving a finger of the interchangeable core lock adapter into engagement with a groove of the large format interchangeable core cavity.

9. The method of claim 8, wherein the body portion includes a length and an elongated slot extending along a portion of the length, the elongated slot being configured to engage a latch of a small format interchangeable core lock.

10. The method of claim 9, wherein the elongated slot includes a proximal edge configured to prevent proximal translation of a latch of a small format interchangeable core lock engaged therewith.

11. The method of claim 8, wherein the body portion forms a figure eight-like shape.

12. The method of claim 11, wherein the step of moving the finger is further defined by moving the finger from a first position where the finger is in substantial alignment with the figure eight-like shape, to a second position where the finger is out of alignment with the figure eight-like shape.
